(19) United States
(12) Patent Application Publication
(10) Pub. No.: US 2009/0254862 A1
(43) Pub. Date: Oct. 8, 2009

(54) METHOD AND APPARATUS FOR USER INTERFACE FOR CHILD ORIENTED COMPUTER NETWORK

(75) Inventors: Vidar Viginisson, San Diego, CA (US); Will Von Reis, Del Mar, CA (US)

Correspondence Address: DLA PIPER US LLP, 1999 AVENUE OF THE STARS, SUITE 400, LOS ANGELES, CA, 90067-6023, US

(73) Assignee: KIDZUI, INC, San Diego, CA (US)

(21) Appl. No.: 12/395,609

(22) Filed: Feb. 27, 2009

Related U.S. Application Data
(60) Provisional application No. 61/033,296, filed on Mar. 3, 2008.

(51) Int. Cl. G06F 3/048

(52) U.S. Cl. 715/810

(57) ABSTRACT

The system provides a method and apparatus for implementing a user interface that is easily usable by children while still providing a rich network browsing environment for the child. The system provides a method of rating network content that is easily understandable by a child and uses images and words that make it easy for the child to accomplish goals and tasks. A unique loyalty system and feature rewards the child for time and activities on the network, allowing the child to obtain software widgets that can enhance the look and/or performance of the network interface. The system also implements a “contextual content presentation” feature that presents options and suggestions to the user based on a number of factors. The child can also customize a home page with a look generated by the child and including network tools selected by the child.

### CROSS REFERENCE TO RELATED APPLICATIONS

This application claims the benefit of U.S. Provisional Application No. 61/033,296, filed March 3, 2008, which is herein incorporated by reference in its entirety.

### BACKGROUND OF THE SYSTEM

1. Field of the Invention

The invention relates to a system for a user interface for a computer network system. In particular, the system provides a user interface for a child oriented computer network.

2. Background of the Invention

The ability to access information via networks such as the Internet has become an accepted part of everyday life. The ability to interact with digital knowledge sources is of such fundamental importance that parents and schools have encouraged computer literacy in children of younger and younger age. Accordingly, young children have regular and ongoing access to computers and in a typical home or school, to information networks such as the Internet.

This increased computer and Internet use by children creates a challenge for parents, who may wish to monitor or filter the information to which a child has access. Moreover, a parent may determine that a child should spend more time using a personal computing device for one thing (such as doing homework) and less time using it for other things (such as playing games). Unfortunately, a modern personal computing device typically does not provide a parent with the controls that would allow the parent to define a policy relating to how a child may use the personal computing device.

There have been some attempts to provide a children safe computing and browsing environment. In some cases, filtering software is provided that enables a parent to block certain web sites from access without a password. In theory, when the parent is surfing the web, the parent can disable the feature or supply the required password when blocked content is desired. The system may also include an ability to search for certain words and phrases and block websites that contain those phrases. The child is prevented from defeating the system due to lack of knowledge of the password.

A disadvantage of prior art systems is that they are designed for adult or young adult use. The interfaces of a traditional web browser require more computer knowledge than most young children have. The complexity of current interfaces can be daunting or discouraging for young users, and the need for parents to actively participate in all network sessions tends to reduce the use of computers by young children. This limits the ability of these children to learn important computing skills that are essential in today's computer centric society.

### BRIEF SUMMARY OF THE SYSTEM

The system provides a method and apparatus for implementing a user interface that is easily usable by children while still providing a rich network browsing environment for the child. The interface includes features that are child oriented and engage the child/user in ways not found in traditional browser interfaces. The system provides a method of rating network content that is easily understandable by a child and uses images and words that make it easy for the child to accomplish goals and tasks. A unique loyalty system and feature rewards the child for time and activities on the network, allowing them to earn points or credits towards customizing features for use on the network interface. The child is encouraged to exercise goal oriented behaviour to earn the requisite points to obtain software widgets that can enhance the look and/or performance of the network interface. The system also implements a “contextual content presentation” feature that presents options and suggestions to the user based on a number of factors, including recent search activity, historical activity, age and gender related group history, and other metrics. The child can also customize a home page with a look generated by the child and including network tools selected by the child.

### BRIEF DESCRIPTION OF THE DRAWINGS

FIG. 1 is a block diagram of an example computer system in an embodiment of the system.

FIG. 2 is a block diagram of an example embodiment of a managed network experience.

FIG. 3 illustrates an example of the custom avatar on the log-in page.

FIG. 4 illustrates an embodiment of avatar customization in the system.

FIG. 5 is an example of a home page in an embodiment of the system.

FIG. 6 illustrates the rating interface in one embodiment of the system.

FIG. 7 is a flow diagram illustrating the operation of the ratings in an embodiment of the system.

FIG. 8 is a flow diagram illustrating the operation of the credit/point reward feature of the system.

FIG. 9 illustrates the presentation of information to the user when the user selects a category.

FIG. 10 is a flow diagram illustrating the operation of the contextual content presentation.

FIGS. 11A-11B illustrate operation of the graphical auto complete feature of the system.

### DETAILED DESCRIPTION OF THE SYSTEM

The present system provides a method and apparatus for providing a user interface on a child oriented network. In the following description, the system is described in connection with an embodiment that manages content to be accessed by children on a network. However, the system is not limited to this embodiment and has application to any situation where content is desired to be managed for a specific audience. The system may be implemented in a child-oriented computer such as is described in U.S. patent application Ser. No. 12/037,082 entitled “Child-Oriented Computer System” filed on Feb. 25, 2008 and incorporated by reference herein in its entirety.

### Example Embodiment

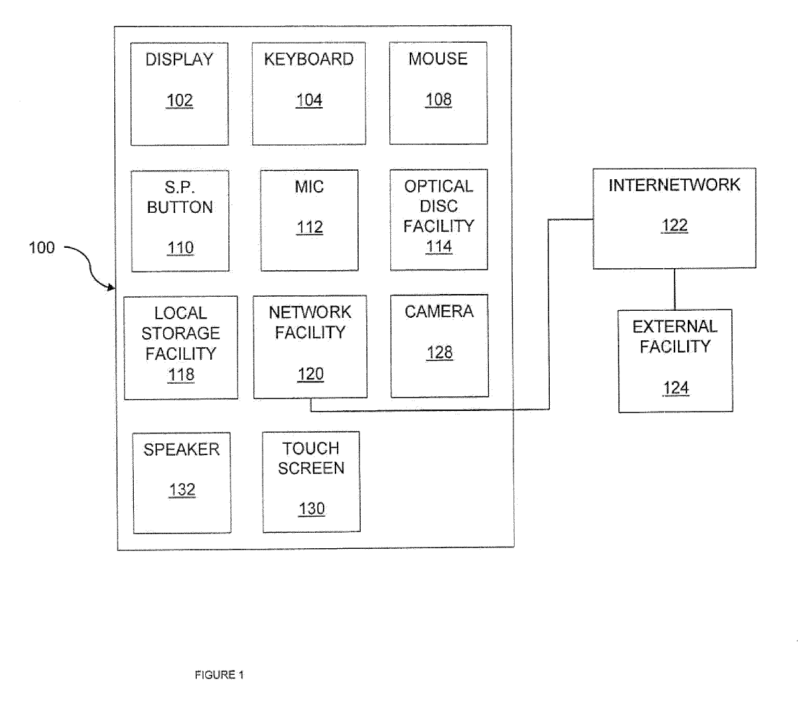

The system contemplates a user (in one embodiment a child) accessing a network using a computing facility of some type. Referring to FIG. 1, in some embodiments, a computing facility 100 may comprise a commercial, off-the-shelf (COTS) computing facility, such as and without limitation a personal computer (PC), a cell phone, a Sony PSP2, and the like. The COTS computing facility may run an operating system such as Linux or a variant thereof, a Microsoft Windows-brand operating system, Mac OS X, and so forth. In the preferred embodiment, the computing facility 100 may comprise a COTS PC.

In embodiments, the computing facility 100 according to the principles of the present invention may comprise the following elements: a display 102; a keyboard 104; a mouse 108; a special-purpose button 110; a microphone 112; a optical disc facility 114; a local storage facility 118; a network facility 120; a camera 128; a touch screen 130; a speaker 132; and so forth. The computing facility may be operatively coupled to a network 122, such as the Internet. The network 122 may, in turn, be operatively coupled to an external facility 124, which is described in detail hereinafter in reference to other figures.

In embodiments, the internal components of the computing facility 100 may include a primary motherboard. The motherboard may include a central processing unit (CPU); RAM memory (which may be the local storage facility 118), such as a RIMM chip, SRAM, DRAM, a BIOS chip; a PCI slot; an Accelerated Graphics Port; a ZIF socket; a disk controller, which may be directed at controlling a hard drive or floppy drive; an additional chipset; an expansion slot; a parallel port; a PS2 port; a serial port; an ATX power connector; a fan; a battery; and so forth. The motherboard may be connected to an external power supply in order to receive power from a standard wall electrical outlet. Additional internal components may include a media drive (of which the optical disc facility 114 may be comprised) and/or ports, such as and without limitation a compact disc player/recorder, a digital video disc player/recorder, removable disk drives (e.g. a USB jump drive, memory card or the like). The internal components may connect with multimedia components, such as an audio speaker and/or the display 102 (which may comprise an LCD, plasma, CRT, LED, holographic, or other monitor or display device).

### Example Software Embodiment

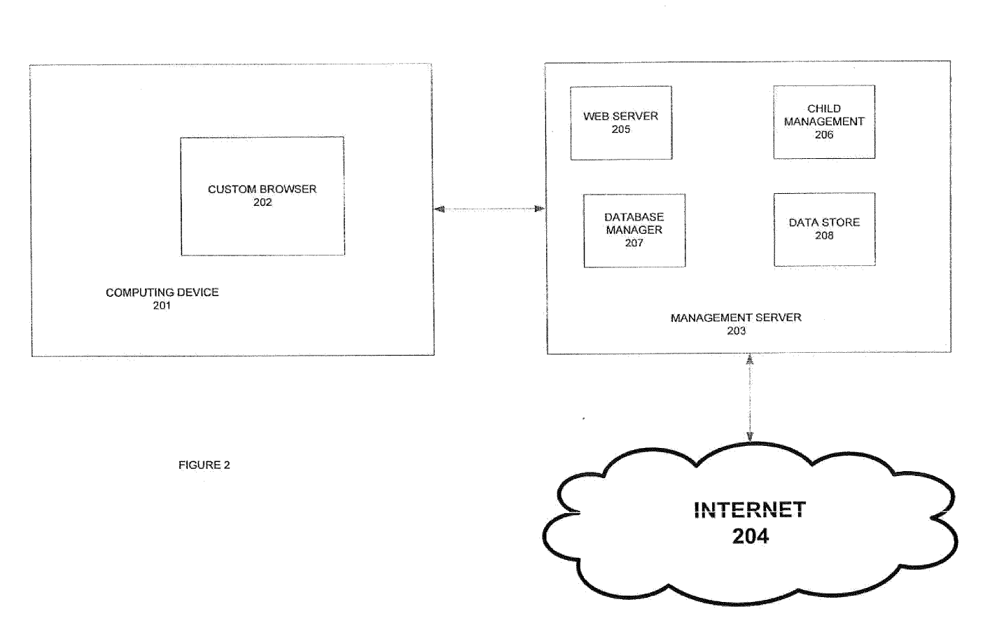

In one embodiment the system uses a custom browser to provide the interface between the user and the Internet. The browser controls all requests and replies so that the user has a layer of protection between himself and the Internet. FIG. 2 illustrates an example implementation of a software embodiment of the child-oriented computing system. In this embodiment, the child-oriented computing system is provided by a piece of software downloaded from a management unit to a computing device wherein one or more children use the downloaded software when installed to browse content. In particular, the system may include a computer 201 that is used by the children to access the Internet. (The computer 201 may be any suitable computing device that is capable of accessing the Internet and may be the example embodiment described in FIG. 1). A typical browser (e.g. Internet Explorer, Netscape, Mozilla, etc.) is replaced with a custom browser 202 that includes browser functions such as searching, multi-media presentation, favourite lists, browsing, chatting, emailing, social networking functions, and the like and whose requests and replies are directed to and from the Internet 204 via a managing server 203. Once installed on the computing device 201, the browser application 202 controls the browsing and web surfing activities of each child that uses the computing device and logs the activities of each child so that the activities can be reviewed by a parent as described in more detail below. In another embodiment, the system is implemented as an add on to a browser, such as for a Firefox browser. In this embodiment, the system functionality is added to an existing browser instead of replacing the browser. This approach can be extended to Linux systems.

The system may further comprise a management server 203 such as one or more server computers in an exemplary embodiment that can be accessed by the computing device over a network, such as the Internet or other network. The computing device 201 may establish a session using the custom browser 202 and then interact with the management server 203 in order to at least: 1) update the browser application; 2) change parental settings; 3) review and approve particular web pages and/or categories of content; 4) download web pages containing the browsing activities and selected content for a particular child; 5) download content categories when the child is browsing using the browser application; and/or 6) provide product recommendations to a parent based on a child's browsing activities. The computing device 201 and management server 203 may also interact to perform other functions and operations as described below in more detail.

The management server 203 may further comprise its own web server 205 that serves web pages to the computing device 201 or downloads content to the browser application 202 among other Functions. The management server 203 may also include a child-oriented content manager application 206 that manages one or more pieces of content that may be browsed by the browser application, and a database management unit 207 that manages the data in a data store 208 such as a database system. The data store 208 may store the data associated with the system such as the user data (child and parent data), content data, category data, web page content and the like. Data store 208 may also store a list of approved IRL's, web pages, web sites, or other content that may be accessed by a user via the network.

Approved Content

In one embodiment, the system operates to limit the content to which a child has access to approved content. That is, content that has already been reviewed and deemed safe by system administrators, by an automatic approval system, by parental approval, or by some other method of approving the content. The system maintains a database of approved content that can include web pages, web sites, video, audio, photographs, graphic images, and other retrievable content. Thus, the system assumes a database of approved content that may be added to over time as new web pages, sites, and media content are created.

Initially, a database of approved content is assembled. In one embodiment, the database is defined by levels (e.g. Level 1 and Level 2). Level 1 is a review of individual media items, i.e. review of a web page, a video, a photo, or any other individual media item. Level 2 review is a review of a collection of media items, i.e. i. reviewing search results and reordering or adding items to the search results. (This is what we call categorization) or ii. reviewing a web domain, evaluating all the pages belonging to a domain, such as nick.com and determining whether every page in the domain should be approved or rejected. Level 2 is generated by incorporating websites from child friendly content sources (e.g. DMOZ, kids directories, Nickelodeon, Disney, etc.). Next, a category list is defined of the categories that are most relevant for children (entertainment, education, etc.). The category list is then populated with the collected content. In one embodiment, the categories were either populated with what was considered the best content or were populated with a ranking, ordering, or weight for each content source. In one embodiment, an editor selects a category (Zebra for example) and the system algorithmically finds the websites believed to be related to the category prioritizes the relevancy of such content based on the search algorithm. At the same time, the system fetches photos and other media content from the creative commons library at FlickR that were tagged with this category and pull videos from sites such as YouTube that met this category key word. The editor would then review the list of websites, photos and videos and pick the most relevant ones to populate a top level of results (e.g. 48 websites, 18 videos and 18 photos). The editor will also rank or order the content so that the most relevant appear in the top positions of a search for that category. The system may perform spidering in the same manner as current search engines.

The system then looks at the individual pages, sites, videos, sound files, photos, images, etc. and approves them on a one-by-one basis. This is the Level 1 category. This is for the content that was not considered to be the top level in the Level 2 exercise above. At this stage, the system may also assign category tags to the content or may rely on the Level 2 categorization. The Level 1 category also includes blocked content that results from a request for unapproved content.
Initially a database of approved content is assembled.

i. from spidering and feeding the results of the spidering to editors for review (i.e. Level 1 review)

ii. from editors searching using commercial search engine or web site search capabilities for individual sites and adding individual items to the database of content

iii. from editors learning of other interesting online media items (from word of mouth, TV, magazines, newspapers, etc.) and adding them individually to the database of content

iv. When kids encounter pages through the KidZui browser that have not been reviewed they are sent to editors for review.

v. The system periodically re-spiders web sites and tries to determine if they have changed sufficiently to require a re-review by editors. If it determines that a re-review is required, the webpage is placed in the editorial queue for review vi. The client reports problems playing videos that do not get played to the back-end server system and those videos get placed in the editorial queue

vii. The client reports pages that do not get loaded, i.e. 404s, 500s etc., and those pages are also placed in the editorial queue
Category lists are defined

i. editors examine popular search terms and create categories based on them. These are used in search auto-completion

ii. editors examine the search results for categories and if they deem them not sufficiently strong, they adjust order of results and the search for additional content to add to the database of approved content to improve the search results

iii. The system examines popular categories and search terms and regularly spiders content from those sources

The above is one example of how to build a database of approved content. However, any other suitable method may be utilized without departing from the scope and spirit of the system.

The system assumes a default content rating method that is deemed acceptable for all children. In one embodiment, the system assembles and adds content that is deemed safe for all children from the ages of three to eleven for example. However, parents may desire a stricter definition of acceptable safe content for their child. In other cases, the parent may wish to time limit access to all or some content, or to make the availability of all or some content conditional on some events or triggers. A parent may also wish to be notified of activity of the child on the network. The system provides a way to accomplish this goal. In addition, the system provides categories of content that parents may want to turn on or turn off for their child. For example, parents may want to turn off content related to reproduction.

Browsing Environment

Children at different ages have differing abilities to comprehend and use a computer. The system aims to provide a simple environment that grows in capability and therefore complexity as the user masters computing. The system user interface therefore adapts based on a child's age and computing skill.

The system desktop environments consist of a custom browser that takes complete control over the computers user interface. This enables the system to provide the different desktop environments to the user based on information that the system has about the user and to enforce the settings that parents have set through the parental control interface. In one embodiment, the custom browser also monitors what other applications are running on the system and terminates applications that are not approved.

The system provides different user interfaces that vary in complexity and capability. The user interface level can change automatically based on age or based on the mastery of computing skills. In one embodiment, the system contemplates different types of interface environments based on the age of the child user. In this embodiment, the interfaces include “early” (three and four year olds) “young” (five and six year olds) “reading” (seven to nine year olds) and “advanced” (ten and eleven year olds).

Early Desktop Environments

The goal of this desktop environment is to teach users the alphabet and numbers. When users press the keyboard they will get a response corresponding to the key/keys that they pressed on the keyboard. The response may change when the same key is pressed repeatedly, for example a different movie or song corresponding to the letter pressed may be played on each key press.

The system may provide instructions. to the child and once selecting the appropriate letter, number or symbol or graphic with the keyboard or mouse reaches a certain level of accuracy, the system provides more advanced combinations to continue challenging the child and to help the child learn. This is also the information is used to determine when the child is ready to move to the next desktop environment.

Young Desktop Environments

All navigation can be done by pressing keys on the keyboard. Mastery of the mouse is not required. Children are not expected to have mastered reading, so all navigation contains audible and visual feedback so that the young user knows where they are. The visual feedback consists of avatars, colors and animations.

The system continues to assess computer skills via games and activities. For example, the system contains a drawing program that teaches users point and click functionality by having the child select colors in paint buckets with a mouse click and then painting with a brush with a drag. Once children have been mastered the drag functionality, they will learn drag and drop functionality using a puzzle game that teaches the child to drag puzzle pieces and drop them in an appropriate location.

In order to make the system easy to use, at this level there is no editing functionality. Users can play games, consume media and create documents or simple drawing. In addition the following age appropriate features will be present. Clocks are digital, as the youngest users are not likely to know how to read an analog clock. All functionality is available via the keyboard. Navigation and launching of applications/features can be accomplished with the remote control. The mouse is functional. Right clicking, double clicking and left clicking all exhibits the same result.

Reader Desktop Environments

At this level simple editing capabilities will be provides, such as cropping pictures with a simple square that can be resized and moved around and the user will be expected to master the use of the mouse. There will be no right click capabilities at this level. Clocks are analog, as users are likely learning how to read an analog clock. Functionality is available via the keyboard, but the mouse is required in some cases. Navigation and launching of applications/features can be accomplished with the remote control. The mouse is functional. All mouse functions occur from left clicking. Right clicking and double clicking do not perform any special functions. Drag and drop capabilities are now provided with the mouse

Advanced Desktop Environments

At the highest level advanced photo editing capabilities will be present along with video editing capabilities. Users will have mastered all aspects of the mouse and will be able to take advantage of right click menus. Users have the ability to customize their environment, for example they can elect to make clocks analog or digital, and they can configure the behavior and look of the desktop environment and applications. All functionality from the less advanced desktops is available. The mouse is fully functional. Right click menus are present and drag and drop capabilities are now provided. Users have all the capabilities that are available in current adult desktop environments

Custom Avatar

The system implements a home page interface for each child that can be customized by the child itself. In one embodiment, the system includes some features that are enabled based on the age and gender of the child, the usage history of the child, or some other metric that determined by the system. This combination of personal customization and system implemented customization results in a unique network browsing environment for the child.

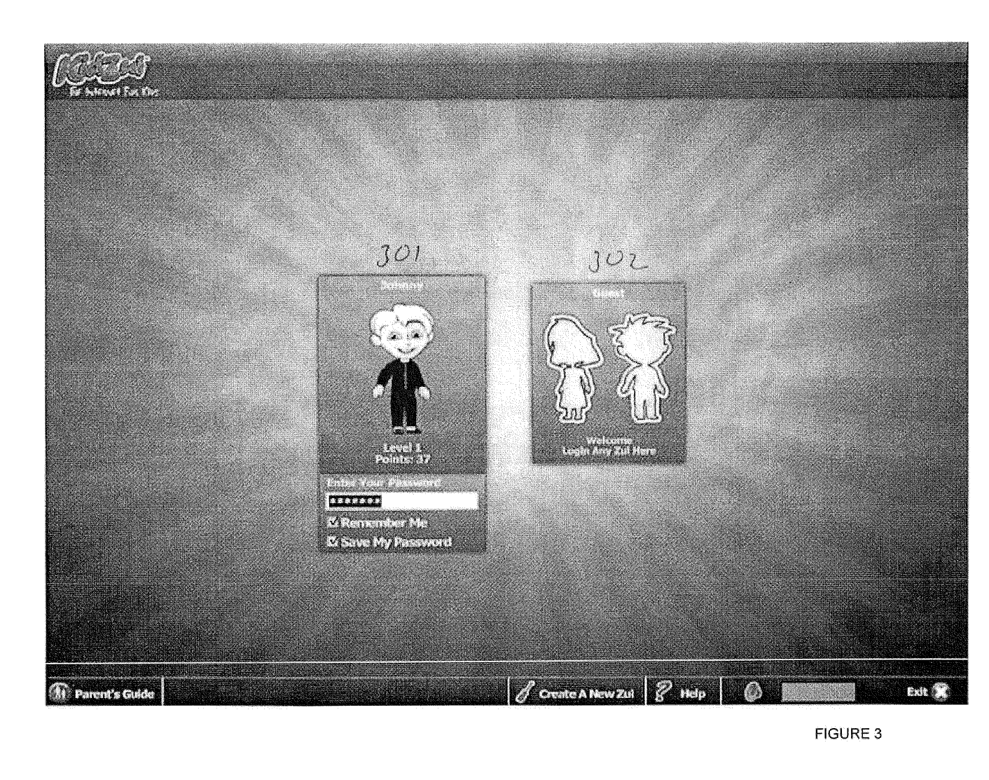

One feature of the system is the ability for the child to create a custom avatar that is an iconographic representation of the child during browsing sessions and in other network activity, such as chatting, IM, email, etc. FIG. 3 illustrates an example of the custom avatar on the log-in page, The page includes the avatar 301 for the user as well as avatars 302 for guests or other users that have access to the system (e.g. siblings of the child). Because children might have difficulty remembering passwords and userIDs, the userID is represented by the avatar itself with the name of the user above, in his case “Johnny”. The child can choose to enable the “remember me” and “save my password” selections so that the child does not need to enter the password during each login. In a household with siblings, the child may prefer to require password entry each time to limit access to the account (it should be noted that the parent/administrator will always have access to the child account).

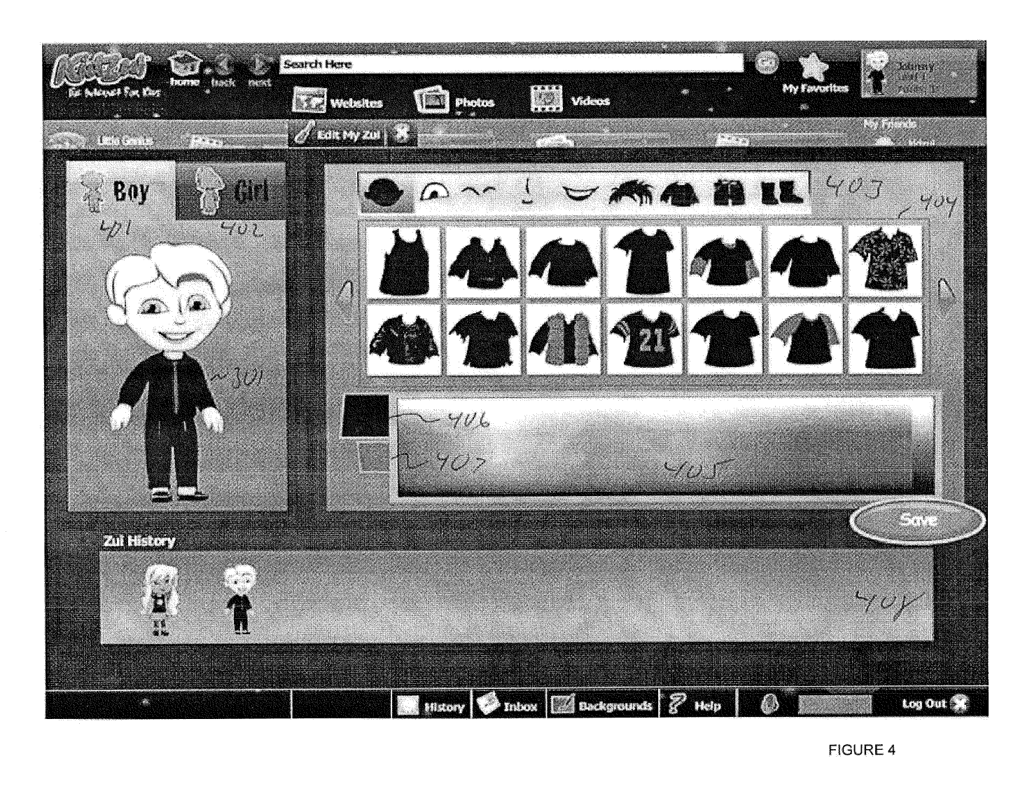

FIG. 4 illustrates an embodiment of avatar customization in the system. The user can select between a boy 401 and girl 402 based avatar type as desired. The page shows the currently selected avatar Johnny 301. The user can customize the avatar via part selection menu 403. This menu, for example, includes customizable separate parts of the avatar, including head, eyes, eyebrows, nose, mouth, hair, shirt, pants, and shoes. When one of the parts is selected in 403, a separate menu 404 appears that gives a plurality of options for that part. In this case the shirt part of the avatar is selected and a plurality of different shirts is presented to the user. If there are more than can be currently displayed in region 404, the system includes right and left scrolling buttons to move the selections back and forth to reveal other options. The system includes a color chooser 405 that allows the user to pick a color for the part. If the part has its own separate components, the system provides a separate color chart for each one, evidenced by color tabs 406 and 407 in FIG. 4. Here the shirt and tie can each be colored independently of each other. As the child selects parts for the avatar, they are shown on the image 301 so that the child can determine the success of the choices made. A history of avatars created is available in region 408 so that previous efforts can be recalled easily.

Home Page

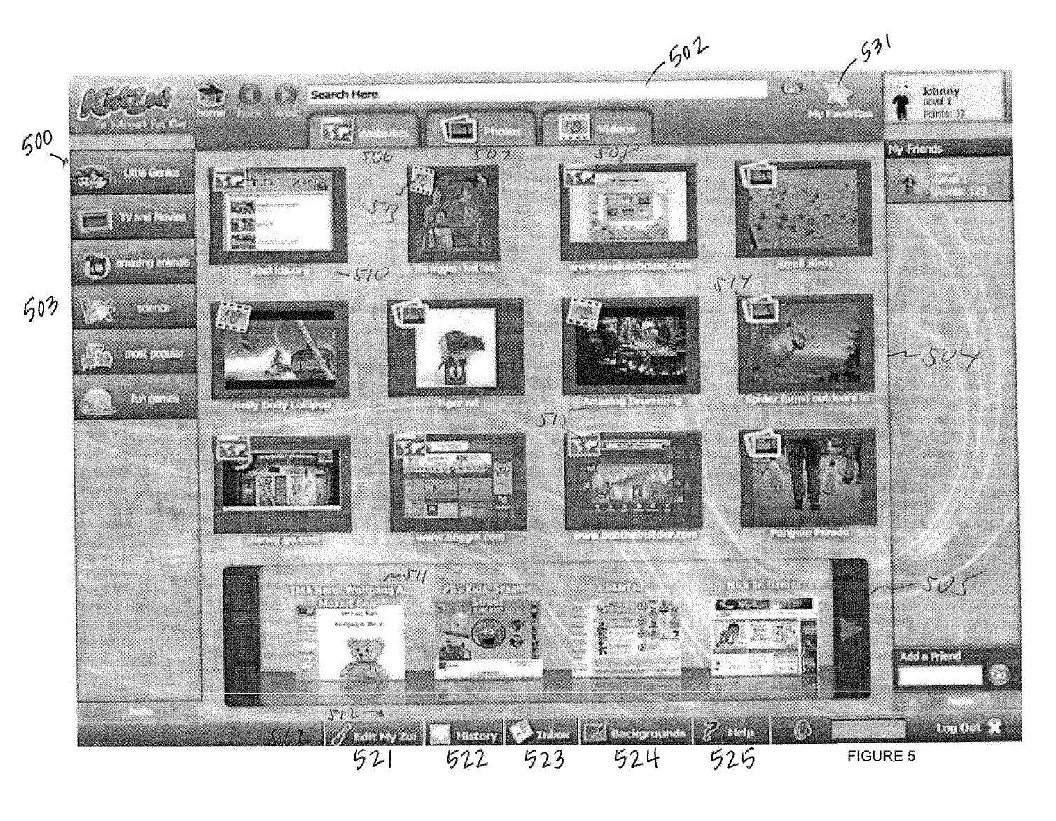

FIG. 5 is an example of a home page in an embodiment of the system. The home page 500 includes a number of different regions that present information to the child in an intuitive manner. A search bar 502 is located at the top of the page and is used to enter text based searches of network content. When a search is performed using the search box 502, the results are retrieved and sorted into their respective categories that are accessible via tabs 506, 507, and 508. In one embodiment, only approved content is presented in a search result listing so that the child is not disappointed that a search has yielded unviewable results. The home page includes a region 504 that presents a series of icons or thumbnails of content that is available to the user. Early in the use of the system by the child, the choices presented may be randomly generated. As the child's use history grows, the offerings in region 504 may be more specific to the child's interests.

The custom browser of the system includes the ability to easily separate data and types of media. For example, region 504 includes a number of icons, each having a tag in the upper left corner. This tag indicates the type of data that is presented. For example, tag 513 is a graphical filmstrip, indicating that the icon represents video data. Tag 514 is a photo, representing photographic or image data. Tag 515 is a world map, indicating that the data is a website from the worldwide web. In one embodiment, these icons are changed over time. For example, in one embodiment, one of the icons appears to rotate and as it turns around a new content icon has taken its place. Even if the user is just viewing the home page, new content and ideas are presented to the user.

The home page may also include a region 505 that displays links to commercial or partner sites such as represented by icon 511 in region 505. This site is a commercial teddy bear vending site in the example given. The partner sites need not be vending sites, but can be associated child friendly sites such as Nickelodeon, Disney, etc.

Region 503 presents a series of tabs that lead to related content based on the title of the tab. This region can be populated automatically by the system based on preferences and history of the user. In other embodiments, this region can be populated by the user as desired. Some of the entries, such as “most popular” by be determined by the system and based on all users, all users of the same age and gender, or all users in the geographical area of the user. Selecting one of the tabs will populate region 504 with content options that are all related to the tab title.

If the user desires to view only a single type of content the system includes taps 506, 507, and 508 for websites, photos, and videos, respectively. Clicking on one of these tabs replaces all of the icons with icons having the same type of corresponding content. By incorporating a photo viewer and video viewer into the browser, the system makes it easier for children to have a fulfilling computer experience without the need to load and execute separate applications for each type of content.

The home page 500 also includes a toolbar 512 that includes a number of options and customizing tools for the user. The user can call up an avatar editing tool 521 if the user desires to edit their avatar. The history tool 522 displays a listing of sites and content visited during the current session. Inbox 523 retrieves the users email inbox. Backgrounds 524 permits the user to select from a plurality of background choices of the home page and other presentation pages. The help tool 525 brings up a help page that can assist the child in learning about different features of the system.

Ratings

One of the features of the system is the ability to rate every piece of content and site using a graphical and customizable ratings interface. This allows the child greater ability to customize content by retrieving content based on a rating given by the child. It also greatly aids in the generation or presentation of content that is more likely to be pleasing to the child, since it will be based on actual revealed preferences. Current web interfaces do not allow the rating of every piece of content as in the present system.

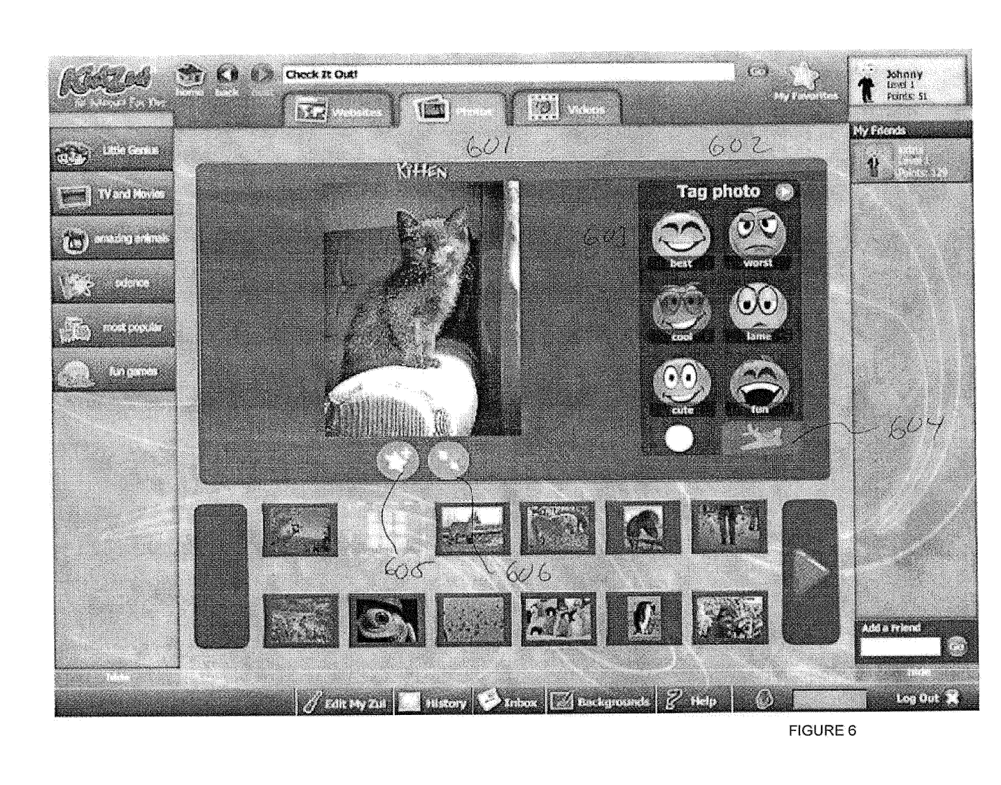

FIG. 6 illustrates the rating interface in one embodiment of the system. Here the user has selected a photo 601 of a kitten. (To see the photo in a larger size, the user clicks on the enlarge button 606). For each piece of content selected, the user has the opportunity to rate the content by tagging it. The “tag photo” menu 602 appears automatically beside each photo that is selected. (A “tag video” menu would appear for videos and “tag site” for websites.) The rating choices are child directed and include iconic representations of the rating level that they represent. Here the choices include best, worst, cool, lame, cute, and fin. The menu includes an arrow to reveal more choices including boring and gross (not shown). The ratings can be updated at anytime and a history of the ratings can be maintained. In one embodiment, the content includes a metadata tag that records the most recent rating given the content by the user. In other embodiments, the user can click on multiple ratings choices and a histogram of the ratings clicks is maintained. The histogram can be processed to generate a score estimating the interest in the rated item (in this case the photo 601) by the user.

The user has the ability to retrieve all rated items by category and/or rating. For example, the user might desire to view all videos that the user has rated as “fin” using the rating system. Alternatively, the user might desire to see all of the “worst” rated web sites.

The ratings menu also includes a tab 604 that enables the user to share the content with other users. Clicking on this tab brings up a menu that allows the user to designate recipients of the content. The recipient will also receive any rating tags the original user has associated with the content.

The system contemplates the ability of a user to take advantage of the ratings systems by aggregating the ratings of all users. An individual user might ask to see the video with the most “cool” ratings of all other users, or all other users categorized by age and/or gender, or by geography. The user may also search for content tagged by all users in the original user's contact or friends list.

The system makes it easy to add content to the favourites list of the user. All content includes the star button 605 that includes either a superscript + or superscript −. If a plus appears, clicking on the button 605 adds the content to the favourites list. If a minus appears, the content is already in the favourites list but can be removed by clicking on the button 605.

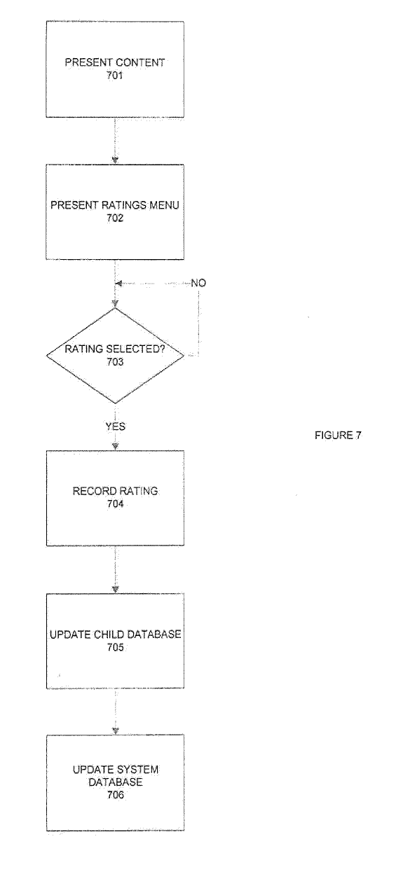

FIG. 7 is a flow diagram illustrating the operation of the ratings in an embodiment of the system. At step 701 content is presented to the user. At step 702 the rating menu is presented with the content to the user. At step 703 the system checks to see if the user has entered a rating. If not, the system returns to step 702. If so, the system records the rating at step 704. At step 705 the system updates the user database with the rating the user has given for the content. At step 706 the system adds the rating to a database of all users who have rated the content.

The system takes additional advantage of the rating system by applying the rating to any categories associated with the content. Any content may be identified as being part of one or more categories. By expanding the rating information to these categories, more detailed knowledge of the likes and dislikes of the user can be accomplished.

In one embodiment, when content is presented, if it has been rated by other children in the child's group of network friends, those ratings are presented as well. The friend's ratings may be cumulative or it may be a scrollable list of each friend so that individual ratings can be viewed.

Loyalty Program

Referring briefly again to FIG. 3, the avatar of the user includes a notation of “Level” and “Points” associated with the user (in this case Level 1 and 37 Points, for example). The system assigns points to each user based on certain activities accomplished by the user. In one embodiment, advancement to another level requires the accumulation of a certain number of points. The system associates a point and level account with each user and updates them appropriately based on the user activity.

The system may award points for viewing content (page, video, photo, etc.) for the first time. The system seeks to reward exploration and inquisitiveness, so repeated visits to content are not rewarded at the same rate as initial visits in one embodiment. A child can also earn points when requesting a blocked page. The points could be greater for a page that is initially blocked and eventually approved, because that enhances the system. A child can also earn points for sharing of content with others, performing searches, or rating content.

Point totals are maintained for each user and the accumulation of points is used to promote a user from a lower level to a higher level. However, the user can also “spend” the points for virtual and physical rewards. (Note that in one embodiment, the spending of points is tracked separately from their accumulation, so that a user who spends all of their points can still be promoted to the next level when the total earned point value warrants such promotion).

Virtual rewards are software widgets and greater customization resources that can enhance the users online experience. For example, the user could purchase new and different items for their avatar using the earned points. These items may be additional options in one of the existing part categories, such as more shirts or hats to choose from. Alternatively, the user might be able to purchase items from an entirely new category, such as transportation (skateboard, bicycle, wagon, sled, scooter, etc.). Other users that view the enhanced avatar will be motivated to earn points to have access to these customizing features.

The reward system can also include software widgets that can be added to a user's interface. These can include animated or sound producing buttons to replace existing buttons. The user might get access to different or more rating icons. Existing rating icons can be enhanced with graphics, animation, or sound. When the user forwards ratings to friends, those friends can view the enhanced rating icons and categories. This motivates participation in the loyalty program.

In one embodiment, certain virtual rewards may be time limited. These rewards will disappear after a set time period (e.g. one month). In other embodiments, the user can spend more points to retain these time limited rewards for another cycle.

In addition to virtual rewards, the system contemplates the ability to earn points towards physical items, including music, software, games, pictures, stickers, etc. This may require parental approval for both participation in, and purchase of, the physical item rewards.

Contextual Content Presentation

The system presents content and information to the user in a fashion that tracks the interests of the user and is referred to as contextual content presentation. Content may associated with one or more categories of content. Some content has no category association, but may show upi results from search terms. Users my go directly to some content by entering a URL. If the search term of this nature is popular, the system may create a matching category based on those search terms. If the search term is not a category, the system calculates a category relationship for the term as results are returned for that search term. In one embodiment, uses can create their own categories, with existing category names and collecting content for those categories, or by defining their own category names and collecting content.

In one embodiment, each piece of content is assigned a score of relevance to each of the plurality of categories available. For most of the categories, that score is zero since there will be no relationship between the content and many of the categories. Where there is a relation between the category and the content, there is a positive score in the category. This score can range from zero to one or it can be set to be any suitable range.

In addition to category relevance scores, the system indexes any keywords available for each piece of content and includes them in metadata associated with the content. The system can also assign scores to the keywords of a piece of content as well.

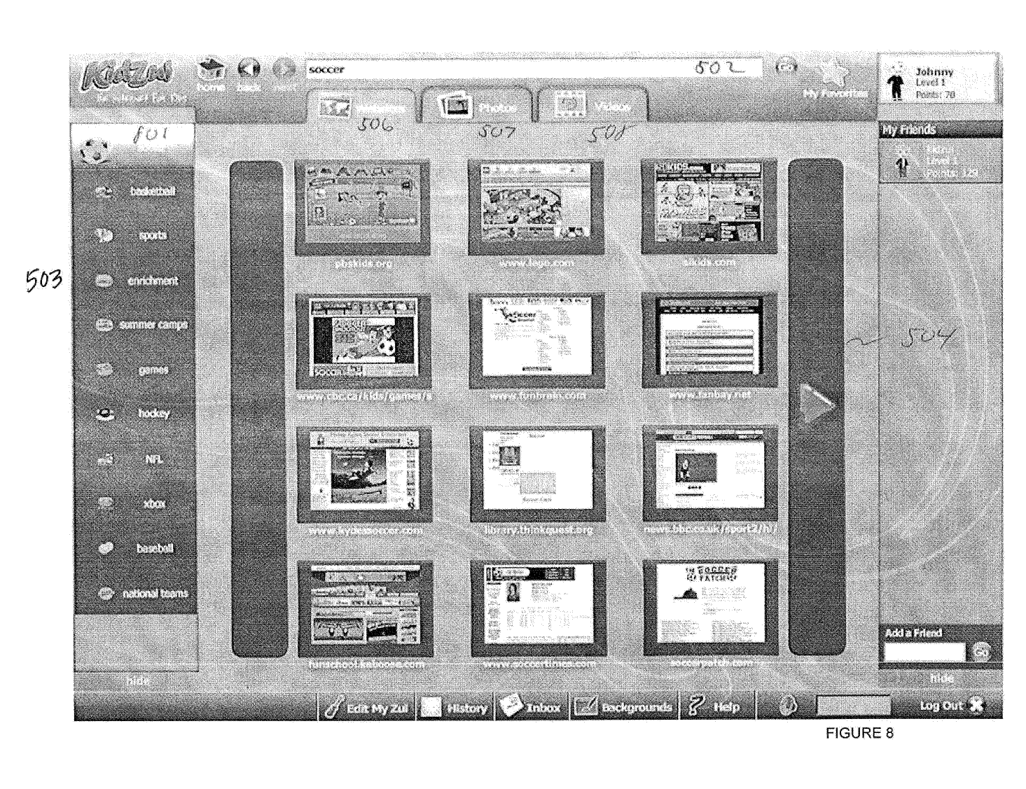

The use of this system is presented to the user by automatically providing related content to the user whenever the user is navigating on the system. This can be illustrated in FIGS. 8-XX. In FIG. 8, the user has performed a search for “soccer” using the search bar 502. The system has retrieved content highly related to soccer and presents that content to the user in region 504. In the image shown, the user has selected the websites tab 506 and is presented with a plurality of soccer related web sites. Clicking on the photo tab 507 would present soccer related photographs and the videos tab 508 would present soccer related videos.

An advantage of the system is found in region 503. Here the top entry 801 is “Soccer”. Soccer is a category in the system. Also presented in region 503 are a plurality of other categories that have relevance scores that are high for the category of soccer. As you might expect, many of these are sport related such as basketball, sports, hockey, NFL, and baseball. But other categories show up as well, including summer camps, games, and xbox. Region 503 provides useful context to the user by highlighting categories that might be of interest to the user. In other systems, a user might have to go through dozens of pages of search results to find contextually related information. Even then, it would be random and not sorted by category.

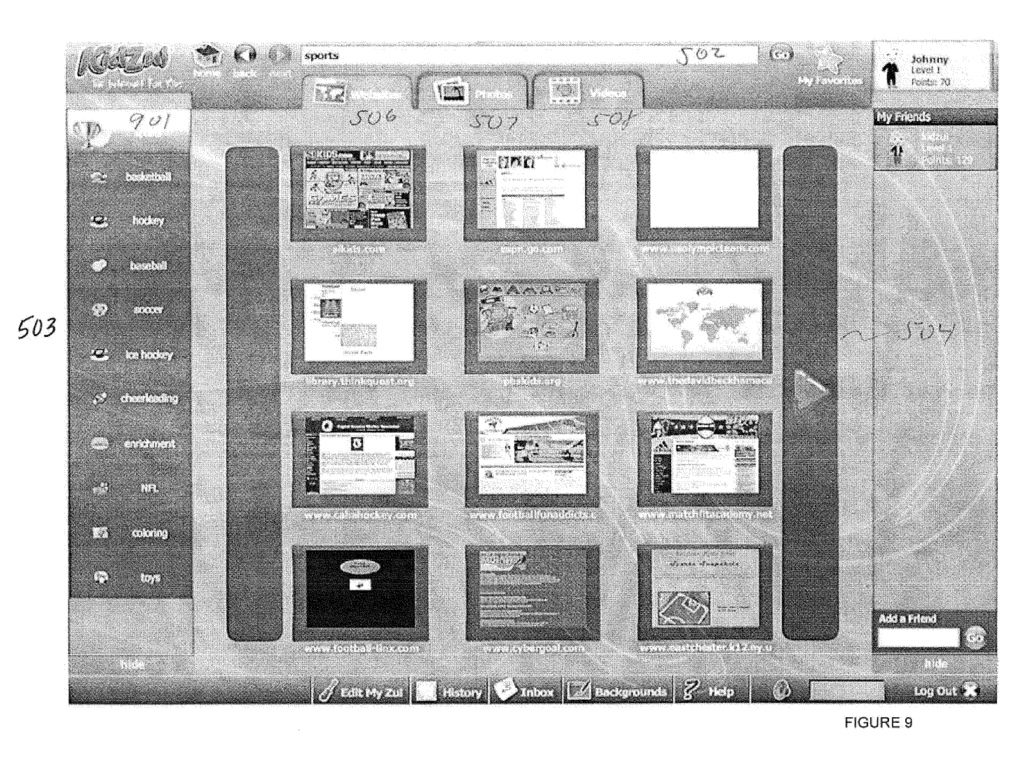

FIG. 9 illustrates the presentation of information to the user when the user selects one of the categories from region 503, in this case “sports”. Now the term “sports” has replaced soccer in search box 502. The sports category 901 is now in the top position of category region 503. Region 504 contains websites relevant to the sports category. In one embodiment, selecting any of the content in region 504, and for any of the tabs 506, 507, and 508, causes the content to be displayed in region 504 but does not alter the choices in region 503. Those categories remain the same until the user selects a different category from that list or performs another search.

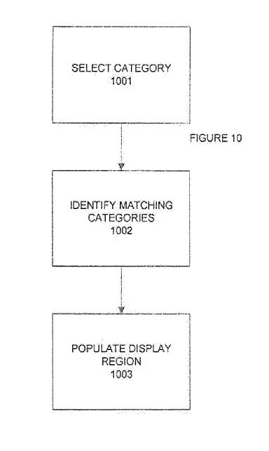

FIG. 10 is a flow diagram illustrating the operation of the contextual content presentation. At step 1001 a user performs a search or selects a category. At step 1002, the system searches the category database to find the best matches of other categories with the selected category. This matching could be done on the fly or it could be done in advance, so that the most related categories are already associated with the selected category. At step 1003, the system populates the contextual content presentation region of the display with the top matching categories of the selected category.

Graphical AutoComplete

The system uses a feature called graphical auto complete to assist young users in formulating searches. When a user begins typing in a search term, the system suggests possible words that the user may intend based on the letters currently typed. Instead of merely presenting a list of possible terms in text form, the system presents the suggestions as words and images. Younger users may be more likely to recognize an image instead of the fully spelled out word. The user can click on the graphical suggestion to initiate the search for that term.

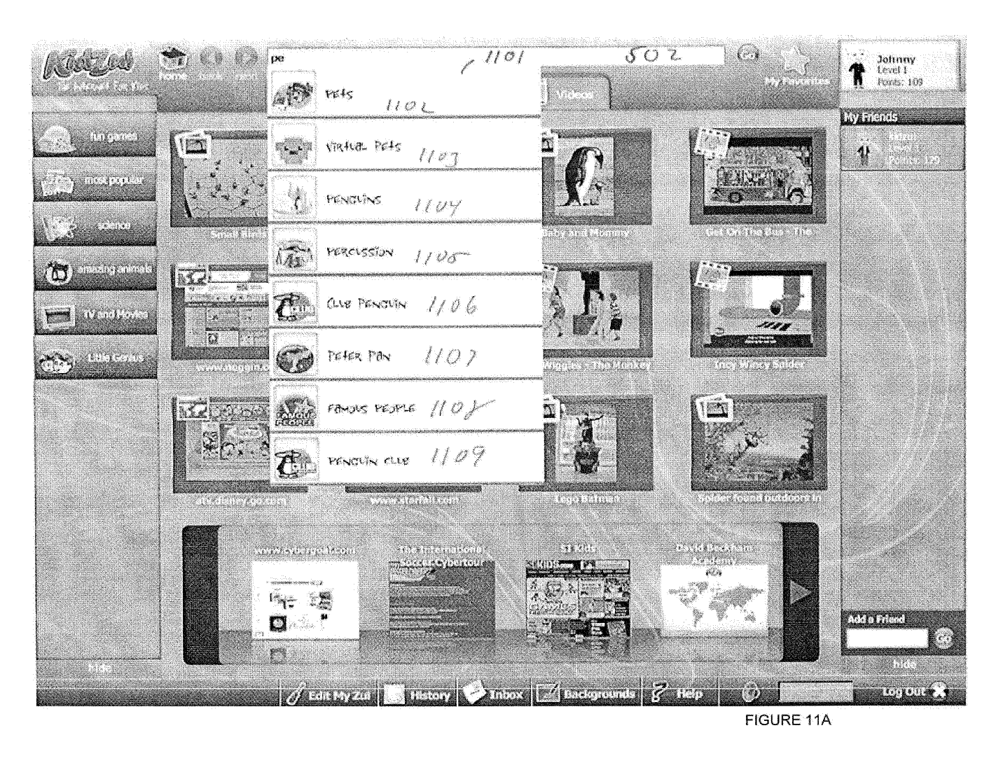

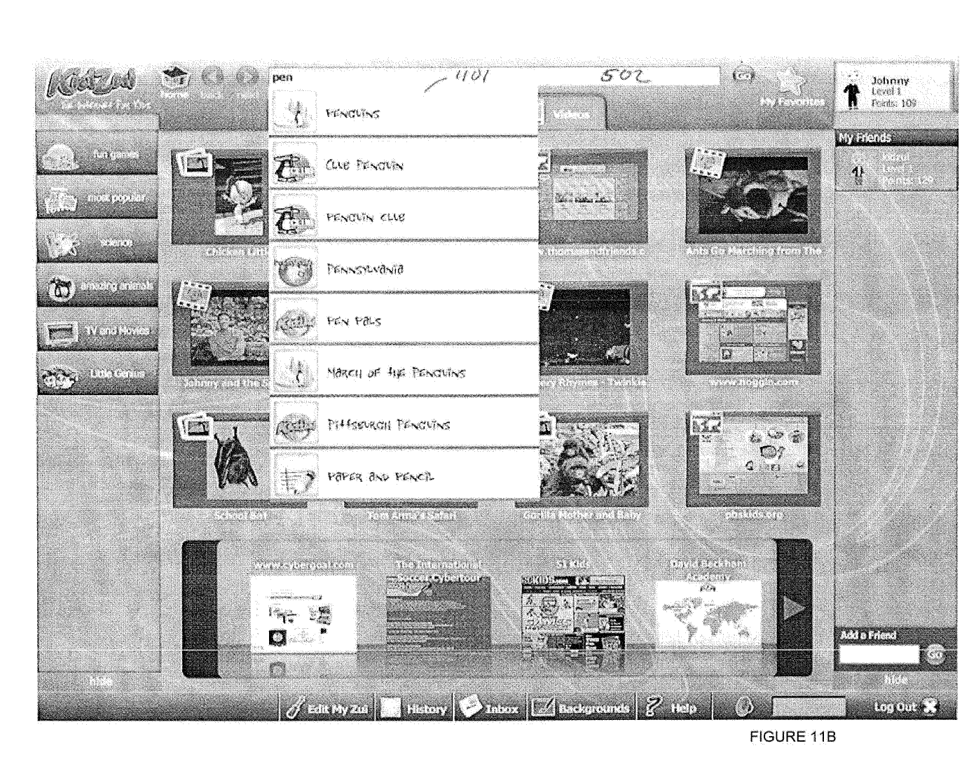

FIGS. 11A-11B illustrate the operation of the graphical auto complete feature. In FIG. 11A, the user has typed the letters “p-e” into the search box 502. A dropdown menu 1101 is presented as the user types and provides suggestions as to what the user may be intending. Each of the suggestions 1102-1109 include graphical icons that assist the user in interpreting what the suggestions may be. Although referred to as auto complete, the system is not limited to just completing the word being typed. For example, suggestion 1106 is for Club Penguin, a popular web site for young people. Although beginning with the word “club”, the suggestion is still offered to the user because of the term “penguin”. Young users might not always remember the exact name of a destination, so the system can present it in a number of different ways. For example, suggestion 1109 is for “penguin club”. The user might not remember if the site is club penguin or penguin club, so both options are provided. In addition, both suggestions share the same graphical logo, the same log that is used by the web site itself. This visual cue lets the user know that both suggestions are for the same site, and by viewing the logo, the user recognizes it as being from the site and can quickly find it in the list and click on the suggestion if that is their destination.

FIG. 11B illustrates the auto complete dropdown menu 1101 after the user has typed in the next letter “n” of the user's search. The system has repopulated the list of suggestions with new entries, each having their own associated graphical icon.

Thus, a method and apparatus for implementing a user interface has been described.

What is claimed is:

1. A method for implementing a user interface comprising:
presenting a piece of content to a user;
presenting a rating menu to the user associated with the piece of content;
selecting one rating from the rating menu;
associating the selected rating with the piece of content.
